(19) United States
(12) Patent Application Publication
(10) Pub. No.: US 2007/0042287 A1
(43) Pub. Date: Feb. 22, 2007

(54) Multi-layer photoresist and method for making the same and method for etching a substrate

(76) Inventor: Jung-Hong Lin, Tainan (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/502,378

(22) Filed: Aug. 11, 2006

(30) Foreign Application Priority Data
Aug. 12, 2005 (TW) 094127620

(51) Int. Cl. G03C 5/00

(52) U.S. Cl. 430/246

(57) ABSTRACT

The present invention relates to a multi-layer photoresist and the method for making the same and method for etching a substrate. The multi-layer photoresist comprises a plurality of photoresist layers, wherein the photoresist layers have different photoreceptive areas. Therefore, the multi-layer photoresist itself has different light transmitting effects. Thus, a substrate is etched to form a 3D structure by utilizing the multi-layer photoresist directly. The conventional process of applying the photoresist for a second time is not necessary, and naturally the disadvantage that the conventional second photoresist layer is not easily controlled is eliminated, thus the etching quality is improved and the efficiency is high.

### BACKGROUND OF THE INVENTION

1. Field of the Invention

The present invention relates to a photoresist and the method for making the same, and more particularly, to a multi-layer photoresist laminated by a plurality of photoresist layers having different photoreceptive areas and the method for making the same, and a method for etching a substrate is etched to form a recess with a 3D structure by using the multi-layer photoresist.

2. Description of the Related Art

Referring to FIG. 1, a schematic sectional view of a conventional substrate is shown. The substrate 10 is, for example, a micro-accelerometer of an optical waveguide element, and it has a recess 11 with a 3D structure. As shown in the figure, the recess 11 has a first space 111 and a second space 112. The second space 112 is located under the first space 111, and the width of the first space 111 is larger than that of the second space 112.

Referring to FIGS. 2 to 5, a conventional method for etching the substrate 10 to form the recess 11 is shown. The conventional method includes the following steps.

First, referring to FIG. 2, a substrate 10 is provided. The substrate 10 has an upper surface 101 and a lower surface 102. Next, a first photoresist layer 12 is coated on the upper surface 101 of the substrate 10. Then, a first mask 13 is provided. The first mask 13 has a first mask pattern 131. Then, a first light beam 14 is provided. The first light beam 14 goes through the first mask pattern 131 and performs an exposure procedure on the first photoresist layer 12.

Then, as shown in FIG. 3, after the exposure procedure, the first photoresist layer 12 performs a development procedure, so as to form a first photoresist pattern 121. The first photoresist pattern 121 corresponds to the first mask pattern 131. Next, an etchant 15 is provided. The etchant 15 etches the substrate 10 according to the first photoresist pattern 121, so as to form the first space 111, as shown in FIG. 4. The first space 111 corresponds to the first photoresist pattern 121.

Then, referring to FIG. 4, a second photoresist layer 16 is coated on the upper surface 101 of the substrate 10 and on a side wall 111a and a bottom wall 111b of the first space 111. Then, a second mask 17 is provided. The second mask 17 has a second mask pattern 171. The second mask pattern 171 is different from the first mask pattern 131. Then, a second light beam 18 is provided. The second light beam 18 goes through the second mask pattern 171 and performs an exposure procedure on the second photoresist layer 16.

Then, referring to FIG. 5, after the exposure procedure, the second photoresist layer 16 performs a development procedure, so as to form a second photoresist pattern 161. The second photoresist pattern 16 corresponds to the second mask pattern 171. Next, an etchant 19 is provided. The etchant 19 etches the bottom wall 111b of the first space 111 according to the second photoresist pattern 161, so as to form the second space 112, as shown in FIG. 1. The second space 112 corresponds to the second photoresist pattern 161.

The disadvantages of the method are as follows. When coating the second photoresist layer 16, as shown in FIG. 4, as the side wall 111a of the first space 111 is vertical, the adhesion between the second photoresist layer 16 and the side wall 111a is not ideal. Moreover, because the first space 111 is a semi-closed space, it is not easy to control the thickness of the second photoresist layer 16 on the bottom wall 111b. Therefore, the coating effect of the second photoresist layer 16 is not ideal.

In addition, during the exposure and the subsequent development procedure on the second photoresist layer 16 performed by the second light beam 18, since it is not possible to observe the second photoresist layer 16 in the first space 111, it is impossible to know when the exposure procedure or the development procedure is finished, and the accuracy and the quality of the exposure or the development are influenced. Similarly, when the etchant 19 etches the bottom wall 111b of the first space 111, the same problem exists, and the quality of etching is influenced.

Finally, the steps of the method are quite complicated, and the manufacturing time is long. A recess structure may be formed by the conventional method, but it has limitations, and it is impossible to form all kinds of complicated 3D recess structures.

Therefore, it is necessary to provide a method for etching a substrate to form a recess with a 3D structure to solve the above problems.

### SUMMARY OF THE INVENTION

The objective of the present invention is to provide a multi-layer photoresist. The multi-layer photoresist comprises a plurality of photoresist layers having different photoreceptive areas. Therefore, the multi-layer photoresist has different light transmitting effects itself, so as to generate a 3D exposing effect. Moreover, after the development procedure, the multi-layer photoresist may form a photoresist pattern with a 3D appearance.

Another objective of the present invention is to provide a method for making a multi-layer photoresist. The method comprises the following steps:

(a) forming a first photoresist layer;

(b) performing an exposure procedure on the first photoresist layer, such that the first photoresist layer has a first photoreceptive area;

(c) forming a second photoresist layer on the first photoresist layer; and

(d) performing an exposure procedure on the second photoresist layer, such that the second photoresist layer has a second photoreceptive area, so as to form a multi-layer photoresist.

Still another objective of the present invention is to provide a method for etching a substrate. The method comprises the following steps:

(a) providing a substrate having an upper surface and a lower surface;

(b) forming a plurality of photoresist patterns with a 3D appearance on the upper surface of the substrate;

(c) etching the photoresist patterns and the substrate simultaneously, such that after the photoresist patterns are removed, the substrate has a 3D recess corresponding to the photoresist patterns.

Thereby, the substrate is etched to form a 3D structure directly, which makes it unnecessary to perform the conventional process of applying the photoresist a second time. Naturally, the disadvantage that the conventional second photoresist layer is not easily controlled is eliminated, thus the etching quality is improved and the efficiency is high.

### BRIEF DESCRIPTION OF THE DRAWINGS

FIG. 1 is a schematic sectional view of the conventional substrate;

FIGS. 2 to 5 show the conventional method for etching a substrate to form a recess;

FIGS. 6 to 11 are schematic views of the method for making a multi-layer photoresist according to the present invention;

FIG. 12 is a schematic view of a photoresist pattern with a 3D appearance according to the present invention;

FIG. 13 is a schematic view of a multi-layer photoresist of the present invention serving as a mask;

FIG. 14 is a schematic view of a photoresist pattern with a 3D appearance according to the present invention; and

FIGS. 15 and 16 are schematic views of the method for etching a substrate according to the present invention.

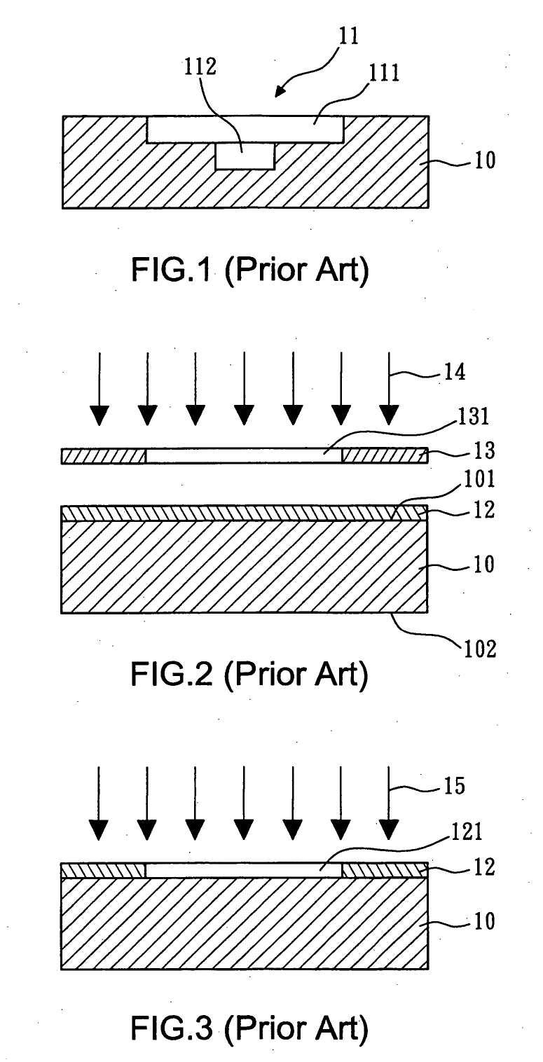

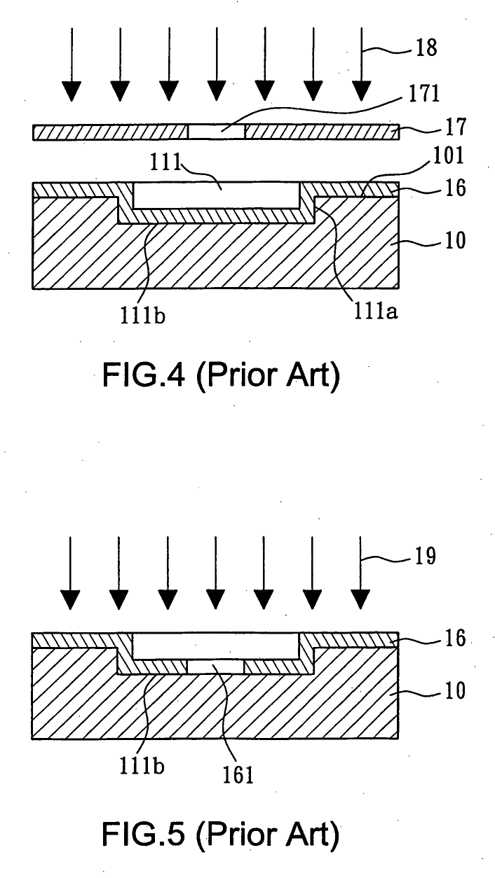

### DETAILED DESCRIPTION OF THE INVENTION

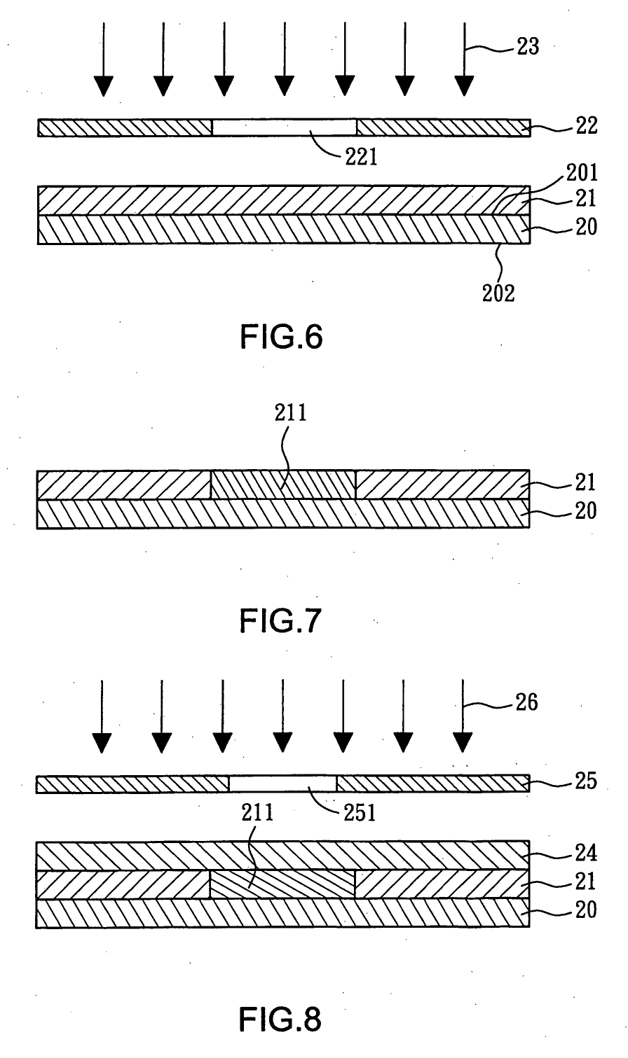

Referring to FIGS. 6 to 11, schematic views of the method for making a multi-layer photoresist according to the present invention are shown. The method of making the multi-layer photoresist of the present invention comprises the following steps.

First, referring to FIG. 6, a substrate 20 (e.g., a micro-accelerometer of an optical waveguide element) is provided, and the substrate 20 has an upper surface 201 and a lower surface 202. Next, a first photoresist layer 21 is formed (e.g., coated) on the upper surface 201 of the substrate 20. Then, an exposure procedure is performed on the first photoresist layer 21, such that the first photoresist layer 21 has a first photoreceptive area 211, as shown in FIG. 7.

In this embodiment, the exposure procedure is described as follows. Referring to FIG. 6 again, firstly, a first mask 22 having a first mask pattern 221 is provided. Next, a first light beam 23 is provided, the first light beam 23 goes through the first mask pattern 221 and performs the exposure procedure on the first photoresist layer 21, so as to form the first photoreceptive area 211, as shown in FIG. 7. The first photoreceptive area 211 corresponds to the first mask pattern 221. Then, if necessary, the first photoresist layer 21 is heated to generate an inversion action for inverting the photosensitive characteristic of the first photoresist layer 21 (for example, from positive to negative), such that the first photoreceptive area 211 has the inverting property. It should be understood that the above-mentioned process of exposing the first photoresist layer 21 is not limited to the above method, and may be accomplished by other methods.

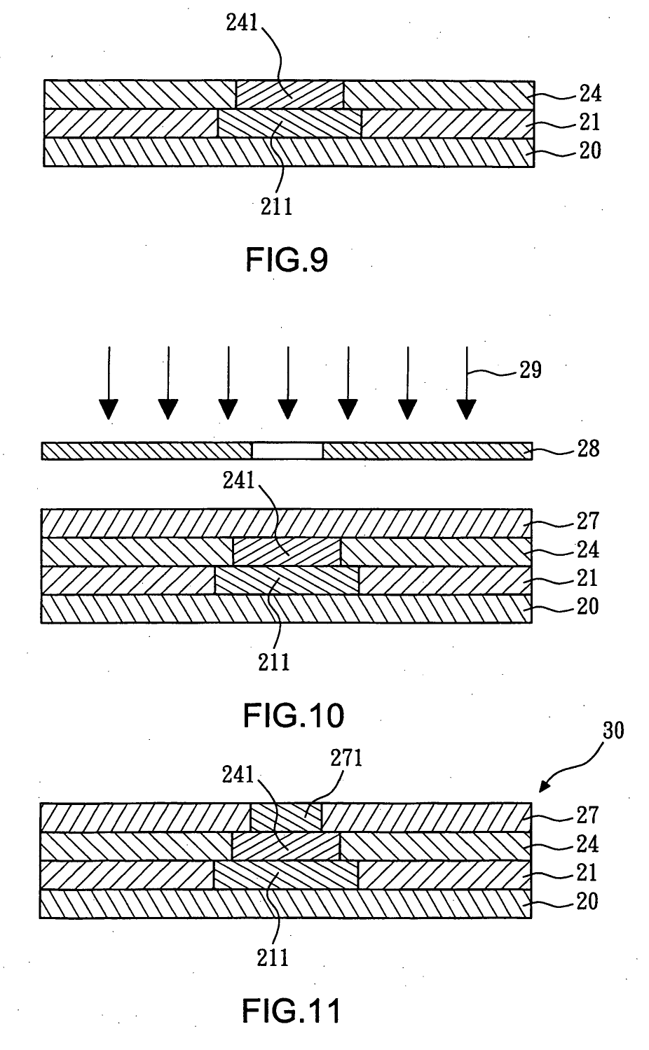

Then, referring to FIG. 8, a second photoresist layer 24 is formed (e.g., coated) on the first photoresist layer 21. Then, the exposure procedure is performed on the second photoresist layer 24, such that the second photoresist layer 24 has a second photoresist area 241, as shown in FIG. 9. The second photoreceptive area 241 and the first photoreceptive area 211 have different shapes or areas, and preferably, the area of the second photoreceptive area 241 is smaller than that of the first photoreceptive area 211.

In this embodiment, the exposure procedure is described as follows. Referring to FIG. 8 again, firstly, a second mask 25 having a second mask pattern 251 is provided. Then, a second light beam 26 is provided, and the second light beam 26 goes through the second mask pattern 251 and performs the exposure procedure on the second photoresist layer 24, so as to form the second photoreceptive area 241, as shown in FIG. 9. The second photoreceptive area 241 corresponds to the second mask pattern 251. Then, if necessary, the second photoresist layer 24 is heated to generate the inversion action, such that the second photoreceptive area 241 has the inverting property. It should be understood that the above-mentioned process of exposing the second photoresist layer 24 is not limited to the above method, and may be accomplished by other methods.

Then, referring to FIG. 10, if it is necessary to laminate a photoresist layer, the above method may be used to form a third photoresist layer 27 on the second photoresist layer 24 firstly. Then, a third mask 28 together with a third light beam 29 are used to perform a exposure procedure on the third photoresist layer 27, such that the third photoresist layer 27 has a third photoreceptive area 271, as shown in FIG. 11.

FIG. 11 shows a schematic view of a multi-layer photoresist according to the present invention. The multi-layer photoresist 30 of the present invention comprises a plurality of photoresist layers, wherein the photoresist layers have different photoreceptive areas. In this embodiment, the multi-layer photoresist 30 comprises a first photoresist layer 21, a second photoresist layer 24 and a third photoresist layer 27. The first photoresist layer 21 has a first photoreceptive area 211, the second photoresist layer 24 has a second photoreceptive area 241, and the third photoresist layer 27 has a third photoreceptive area 271. The first photoreceptive area 211, and the second photoreceptive area 241 and the third photoreceptive area 271 have different shapes or areas. Preferably, the first photoreceptive area 211 is larger than the second photoreceptive area 241, and the second photoreceptive area 241 is larger than the third photoreceptive area 271. It should be understood that the multi-layer photoresist of the present invention is not limited to three layers, it may be two layers, four layers or more than five layers.

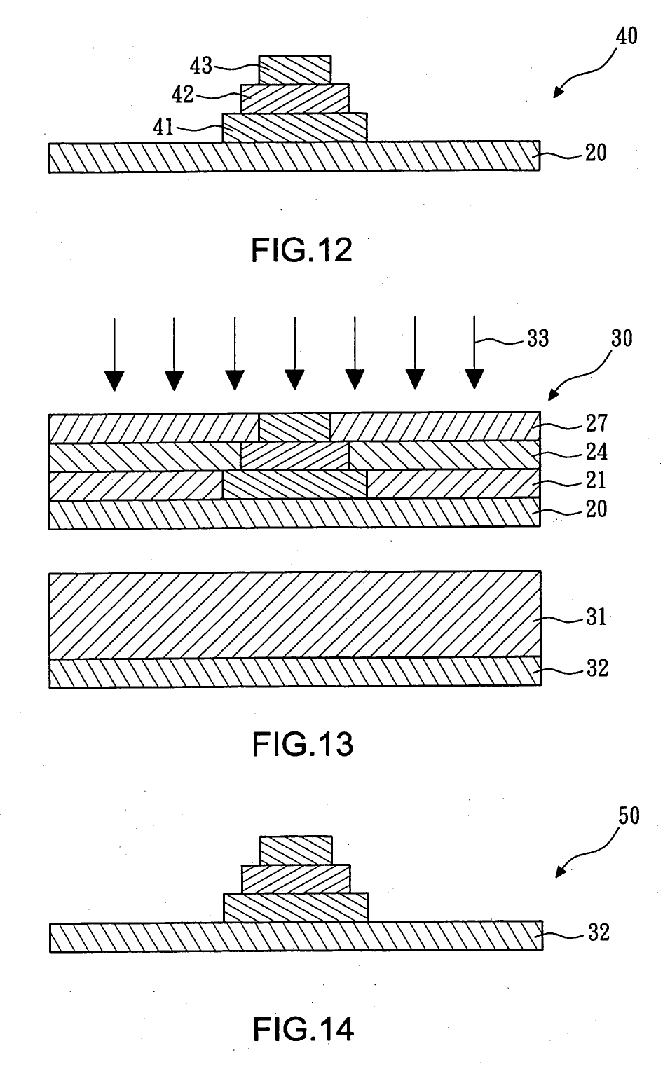

FIG. 12 shows a schematic view of a photoresist pattern with a 3D appearance according to the present invention. The 3D photoresist pattern 40 comprises a plurality of photoresist patterns, wherein the photoresist patterns have different shapes or areas. In this embodiment, the 3D photoresist pattern 40 is formed by directly performing a development procedure on the multi-layer photoresist 30 (FIG. 11), so as to remove the non-photoreceptive areas of the first photoresist layer 21, the second photoresist layer 24 and the third photoresist layer 27, and leave a first photoresist pattern 41, a second photoresist pattern 42 and a third photoresist pattern 43. The first photoresist pattern 41 is the first photoreceptive area 211, the second photoresist pattern 42 is the second photoreceptive area 241, and the third photoresist pattern 43 is the third photoreceptive area 271.

FIG. 13 shows a schematic view of the multi-layer photoresist 30 of the present invention serving as a mask. In the multi-layer photoresist 30, the light transmittance of the photoreceptive area of each photoresist layer is different from that of the non-photoreceptive area of the photoresist layer, thus the multi-layer photoresist 30 may be used as a mask. The method is described as follows, firstly, a bottom photoresist layer 31 is formed on a substrate 32. Next, a light beam 33 is provided, the light beam 33 goes through the multi-layer photoresist 30 and performs an exposure procedure on the bottom photoresist layer 31. Finally, a development procedure is performed to partially remove the bottom photoresist layer 31, so as to form a photoresist pattern 50 with a 3D appearance, as shown in FIG. 14.

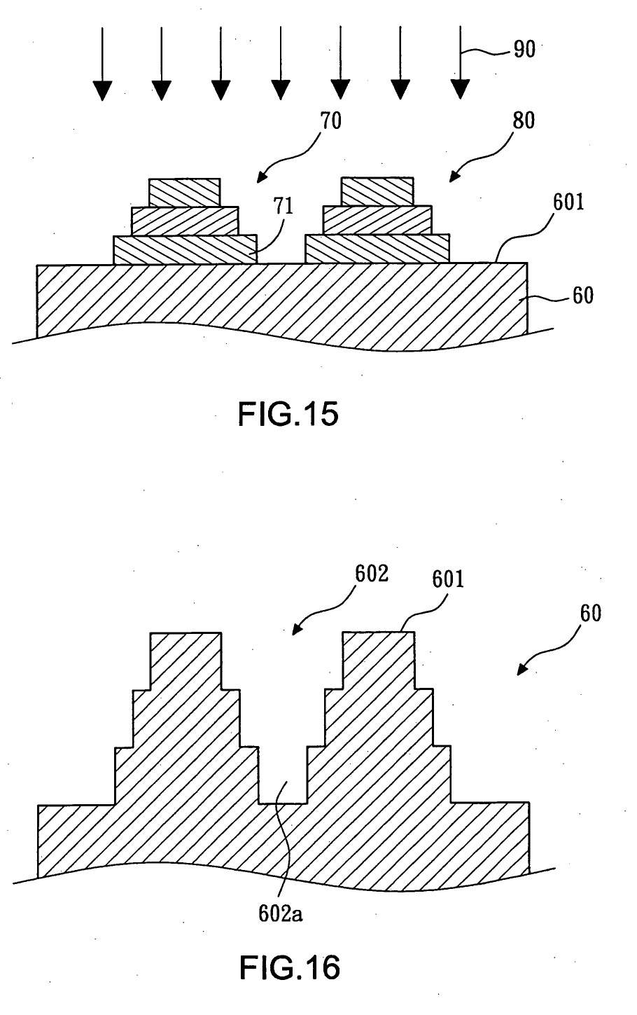

Referring to FIGS. 15 and 16, the schematic views of the method for etching the substrate according to the present invention are shown. First, a substrate 60 having an upper surface 601 is provided. Next, a plurality of photoresist patterns 70, 80 with a 3D appearance are formed on the upper surface 601 of the substrate 60. In this embodiment, the photoresist patterns 70, 80 have the same appearance, but the present invention is not limited to this. That is, the photoresist pattern 70 may be different from the photoresist pattern 80, depending on the final desired recess appearance or the substrate appearance. It should be understood that the substrate 60 may be etched to form an arc appearance by a special design.

The method for forming the photoresist patterns 70, 80 with a 3D appearance is described above. Then, an etchant 90 is used to etch the photoresist patterns 70, 80 and the substrate 60 simultaneously. The photoresist patterns 70, 80 have a 3D appearance, and thus have different degrees of blocking effect against the etchant 90. After the photoresist patterns 70, 80 are removed by the etchant 90, the substrate 60 has a 3D recess 602 corresponding to the photoresist patterns 70, 80. It should be noted that the etching ratio of the etchant 90 to the photoresist patterns 70, 80 and the substrate 60 may be selected to achieve a relatively high aspect ratio. As for this embodiment, the etching ratio of the etchant 90 to the photoresist patterns 70, 80 and the substrate 60 is 1:18, thus after etching, the height of the first space 602a in the recess 602 is 18 times that of the first photoresist layer 71 of the photoresist pattern 70.

In the present invention, the etchant 90 is directly used to simultaneously etch the photoresist patterns 70, 80 and the substrate 60, thus the conventional process of applying the photoresist for a second time is not necessary, and naturally the disadvantage that the conventional second photoresist layer is not easily controlled is eliminated, therefore the etching quality is improved and the efficiency is high.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope as defined in the appended claims.

What is claimed is:

1. A multi-layer photoresist, comprising:
a first photoresist layer, having a first photoreceptive area; and
a second photoresist layer, formed on the first photoresist layer, the second photoresist layer having a second photoreceptive area, wherein the second photoreceptive area is different from the first photoreceptive area.

2. The multi-layer photoresist as claimed in claim 1, further comprising a third photoresist layer having a third photoreceptive area, wherein the third photoresist layer is formed on the second photoresist layer, and the third photoreceptive area is different from the second photoreceptive area.

3. A method for making a multi-layer photoresist, comprising the following steps:
(a) forming a first photoresist layer;
(b) performing an exposure procedure on the first photoresist layer, such that the first photoresist layer has a first photoreceptive area;
(c) forming a second photoresist layer on the first photoresist layer; and
(d) performing an exposure procedure on the second photoresist layer, such that the second photoresist layer has a second photoreceptive area, so as to form a multi-layer photoresist.

4. The method as claimed in claim 3, wherein after step (d), the method further comprises:
(e) forming a third photoresist layer on the second photoresist layer; and
(f) performing an exposure procedure on the third photoresist layer, such that the third photoresist layer has a third photoreceptive area.

5. The method as claimed in claim 3, wherein in step (b), a first light beam is used to go through a first mask so as to perform the exposure procedure on the first photoresist layer.

6. The method as claimed in claim 3, wherein in step (d), a second light beam is used to go through a second mask so as to perform the exposure procedure on the second photoresist layer.

7. The method as claimed in claim 3, further comprising a step of heating the first photoresist layer to make the first photoreceptive area form a first inversion area after step (b).

8. The method as claimed in claim 3, further comprising a step of heating the second photoresist layer to make the second photoreceptive area form a second inversion area after step (d).

9. The method as claimed in claim 3, wherein the area of the second photoreceptive area is smaller than that of the first photoreceptive area.

10. The method as claimed in claim 3, further comprising a step of performing a development procedure to partially remove the first photoresist layer and the second photoresist layer, so as to form a photoresist pattern with a 3D appearance after step (d).

11. The method as claimed in claim 3, wherein after step (d), the method further comprises:
(d1) forming a bottom photoresist layer;
(d2) providing a light beam, wherein the light beam goes through the multi-layer photoresist so as to perform an exposure procedure on the bottom photoresist layer; and
(d3) performing a development procedure, for partially removing the bottom photoresist layer, so as to form a photoresist pattern with a 3D appearance.

12. A photoresist pattern with a 3D appearance, comprising:
a first photoresist pattern; and
a second photoresist pattern, formed on the first photoresist pattern, wherein the second photoresist pattern is different from the first photoresist pattern.

13. The photoresist pattern as claimed in claim 12, wherein the shape of the first photoresist pattern is different from that of the second photoresist pattern.

14. The photoresist pattern as claimed in claim 12, wherein the area of the first photoresist pattern is different from that of the second photoresist pattern.

15. The photoresist pattern as claimed in claim 12, further comprising a third photoresist pattern, formed on the second photoresist pattern, wherein the third photoresist pattern is different from the first photoresist pattern.

16. A method for etching a substrate, comprising the following steps:
(a) providing a substrate having an upper surface and a lower surface;
(b) forming a plurality of photoresist patterns with a 3D appearance on the upper surface of the substrate;
(c) providing an etchant having a predetermined etching ratio; and
(d) etching the photoresist patterns and the substrate simultaneously, such that after the photoresist patterns are removed, the substrate has a 3D recess corresponding to the photoresist patterns.
